(19) United States
(12) Patent Application Publication
(10) Pub. No.: US 2014/0330651 A1
(43) Pub. Date: Nov. 6, 2014

(54) SYSTEM AND METHOD FOR SOCIAL MEDIA-AWARE ADVERTISEMENT BROKERING

(71) Applicant: Avaya Inc., Basking Ridge, NJ (US)

(72) Inventors: Reinhard P. Klemm, Basking Ridge, NJ (US); Doree Duncan Seligmann, New York, NY (US)

(21) Appl. No.: 13/925,942

(22) Filed: Jun. 25, 2013

Related U.S. Application Data
(60) Provisional application No. 61/819,301, filed on May 3, 2013.

(51) Int. Cl. G06Q 30/02

(52) U.S. Cl. CPC G06Q 30/0269; G06Q 30/0275
USPC 705/14.66

(57) ABSTRACT

An advertisement brokering system for social media-aware advertisement brokering is provided. The advertisement brokering system includes a processor and a memory, wherein the memory comprises a rules database and plurality of modules. The memory further comprises a data mining module for mining data from predetermined resources based upon predefined characteristics and behavioral traits of users. The memory further comprises an analysis module for identifying users based on match of the mined data with the predefined characteristics and/or behavioral traits. The memory further comprises a brokering module for offering advertising services to the identified users. The memory further comprises a feedback module for notifying an advertiser corresponding to change in behavioral activities of the identified users after offering advertising services. The memory further comprises a calibration module for calibrating advertising services based on change noticed in behavioral activities of the identified users.

### CROSS-REFERENCE TO RELATED APPLICATIONS

This application claims the benefit of U.S. Provisional Application Ser. No. 61/819,301 filed May 3, 2013, entitled “SYSTEM AND METHOD FOR SOCIAL MEDIA-AWARE ADVERTISEMENT BROKERING,” which is incorporated herein by reference in its entirety.

### BACKGROUND

1. Field of the Invention

Embodiments of the present invention generally relate to advertising systems. More specifically, the present invention relates to advertisement brokering based on real-time monitoring of social media.

2. Description of Related Art

Generally, advertisements are known to be a common method used by various enterprises to promote their business. Advertising methods include providing promotions on newspapers, magazines, television networks, and Internet etc. A common purpose of the advertisements is to spread awareness (among advertized audience) corresponding to advertized products or services and to further engage the advertized audience in business related activities. Furthermore, various enterprises target users, specifically on social networks, for providing tailored advertisements to a group of audience having common characteristics. However, effectiveness of such web-based advertisements has always been a concern for the enterprises.

Moreover, it is common for the enterprises and advertising agencies to bid for space on various channels such as, but not limited to web sites, television, social networks, magazines, or radio etc. More particularly, the advertising agencies bid for rights to advertise on the channels to target audiences based on desired demographics, or certain pre-defined characteristics. However, the advertising agencies have limited information available corresponding to their target audiences and are bound to bid based on the limited information.

Further, the enterprises and the advertising agencies spend a lot of money, time, and resources in gathering feedback from the targeted audiences via surveys or feedback forms. The enterprises and the advertising agencies use such feedbacks to interpret effectiveness, success, failures, or improvement scopes in their advertising campaigns. The feedbacks may also be used by the enterprises to improve their products and services. In addition, based on the feedbacks, the enterprises may also offer personalized advertisements. However, the advertising agencies have limited insight into responses of the targeted audiences against the personalized advertisements. The advertising agencies need to re-survey the targeted audiences to judge effectiveness of the personalized advertisements, which is time consuming, expensive, and not even a reliable method.

Furthermore, the enterprises depend highly on results gathered by their advertising agencies corresponding to the effectiveness, success, or failures of their previous advertising campaigns. In addition, to build future strategies, research teams and marketing teams of the enterprises need a lot more information, such as, but not limited to, whether the advertisements are reaching their intended audience, whether the intended audience noticing the advertisements, whether the intended audience is swayed by the advertisements, etc. However, such information is either not available to the advertising agencies or is not effectively gathered by the agencies. Therefore, most of marketing decisions are either made upon incomplete information or faulty information.

Therefore, there is a need of a method and system for gathering feedbacks from the targeted audience. Further, there is a need of a method and system that can monitor real time activities of the targeted audience to enable enterprises and marketing agencies to personalize advertisements based on current activities of the targeted audience.

### SUMMARY

Embodiments in accordance with the present invention provide an advertisement brokering system comprising a data mining module for mining data from predetermined resources based upon predefined characteristics of users and behavioral traits of the users. The advertisement brokering system further comprises an analysis module for identifying users based on match of the mined data with the predefined characteristics and behavioral traits of the users. The advertisement brokering system further comprises a brokering module for offering advertising services to the identified users.

Embodiments in accordance with the present invention further provide a computer-implemented method for brokering advertisement services. The computer-implemented method includes mining data from predetermined resources based upon predefined characteristics of users and behavioral traits of the users, identifying users based on match of the mined data with the predefined characteristics and behavioral traits of the users, and offering advertising services to the identified users.

Embodiments in accordance with the present invention further provide a computer readable medium storing computer readable instructions when executed by a processor performs a method. The method includes mining data from predetermined resources based upon monitored online behavioral activities and predefined characteristics of users. The method further includes identifying users based on match of the mined data with the predefined characteristics and behavioral traits of the users and offering advertising services to the identified users.

The present invention can provide a number of advantages depending on its particular configuration. The present invention allows advertisers to define a list of desired customer characteristics and then to target customers based on the predefined desired customer characteristics and behavioral traits. Further, the present invention makes use of public visibility of social media users and their business activities and interactions on public social networks to compute user migration patterns across social network pages for the purpose of sales, marketing, or representing a business on the social network sites. Further, the present invention allows the advertisers to measure impact of advertising and marketing campaigns after a bidding process is offered to the customer.

Further, the present invention continuously monitors activities and behavior of the users on company-related social networking pages, e.g., Facebook page(s) devoted to a business, Twitter pages or feeds, etc. The company-related social networking pages may be as created and/or maintained by and/or for substantially any entity such as the business itself, a fan club (e.g., for a musical band, movie, movie star, other publicity seekers, etc.), a political action committee, non-profit organizations, and so forth.

Furthermore, according to an aspect of the present invention, the social networking pages may be grouped into a configurable set of pages referred to as a ‘page mix’. Activities may include posts, comments, likes, tags, photos, and all other publicly visible user and Page owner expressions. The ‘Page mix’ may contain a business' known competitors' Pages but also any other business Facebook Pages. Monitoring means recording all new activities and adding them to a repository of activities that can be searched by either Page ID or activity owner ID.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a system in accordance with an embodiment of the present invention;

FIG. 2 illustrates a network environment in which the various embodiments of the present invention may be implemented;

FIG. 3 illustrates an exemplary view of a user-profile created by an advertisement brokering system for advertisers, in accordance with an embodiment of the present invention; and

FIGS. 4A, 4B, and 4C illustrate a method for brokering advertisement services, in accordance with an embodiment of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any communication application in which it is desirable to observe social media usage.

The exemplary systems and methods of this disclosure will also be described in relation to software, modules, and associated hardware. However, to avoid unnecessarily obscuring the present disclosure, the following description omits well-known structures, components and devices that may be shown in block diagram form, are well known, or are otherwise summarized.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

The term “computer-readable medium” as used herein refers to any tangible storage and/or transmission medium that participate in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

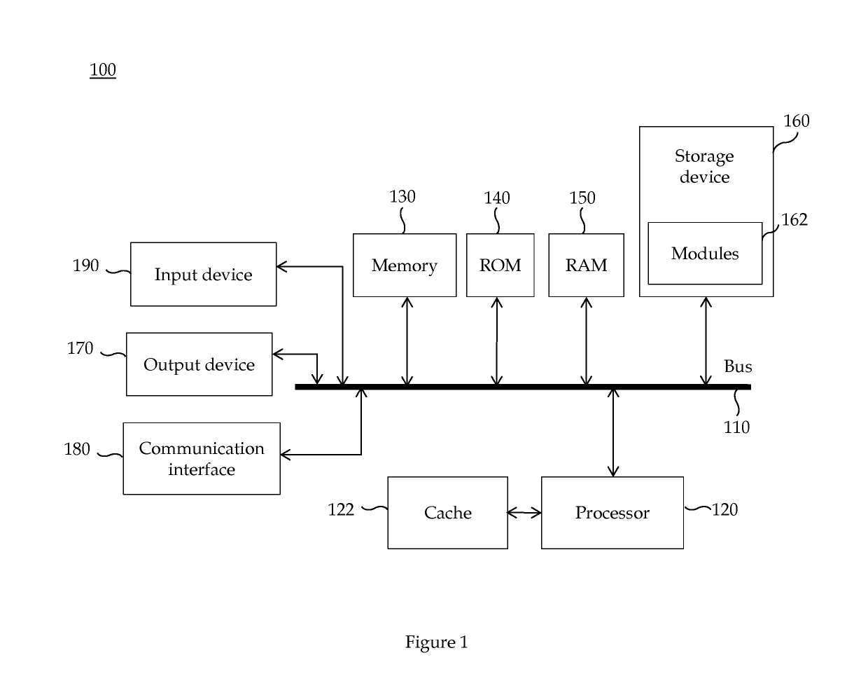

With reference to FIG. 1, an exemplary system includes a general-purpose computing device 100, including a system bus 110 and a processing unit (CPU or processor) 120 that couples various system components including the system memory 130 such as read only memory (ROM) 140 and random access memory (RAM) 150 to the processor 120. The system may include a cache 122 of high speed memory connected directly with, in close proximity to, or integrated as part of the processor 120. The system copies data from the memory 130 and/or the storage device 160 to the cache 122 for quick access by the processor 120. In this way, the cache 122 provides a performance boost that avoids processor 120 delays while waiting for data. These and other modules may control or be configured to control the processor 120 to perform various actions. Other system memory 130 may be available for use as well. The memory 130 may include multiple different types of memory with different performance characteristics. It may be appreciated that the disclosure may operate on a computing device 100 with more than one processor 120 or on a group or cluster of computing devices networked together to provide greater processing capability. The processor 120 may include any general purpose processor and a hardware module or software module 162 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 may include software modules 162 for controlling the processor 120. Other hardware or software modules are contemplated. The storage device 160 is connected to the system bus 110 by a drive interface. The drives and the associated computer readable storage media provide non-volatile storage of computer readable instructions, data structures, program modules and other data for the computing device 100. In one embodiment of the present invention, a hardware module that performs a particular function includes the software component stored in a computer-readable medium in connection with the necessary hardware components, such as the processor 120, bus 110, output device 170, and so forth, to carry out the function. The basic components are known to those of skill in the art and appropriate variations are contemplated depending on the type of device, such as whether the device 100 includes a small, handheld computing device, i.e., a Smartphone, a desktop computer, or a computer server.

Although the exemplary embodiment described herein employs the hard disk 160, it should be appreciated by those skilled in the art that other types of computer readable media which may store data that are accessible by a computer, such as magnetic cassettes, flash memory cards, digital versatile disks, cartridges, read only memory (ROM) 140, random access memories (RAMs) 150, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 180 represents any number of input mechanisms, such as a microphone for speech, a touch-sensitive screen for gesture or graphical input, keyboard, mouse, motion input, speech and so forth. An output device 170 may also be one or more of a number of output mechanisms known to those of skill in the art. In some instances, multimodal systems enable a user to provide multiple types of input to communicate with the computing device 100. Communication interface 190 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. Further, use of the term “processor” should not be construed to refer exclusively to hardware capable of executing software. Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system shown in FIG. 1 may practice all or part of the recited methods, may be a part of the recited systems, and/or may operate according to instructions in the recited non-transitory computer-readable storage media. Such logical operations may be implemented as modules configured to control the processor 120 to perform particular functions according to the programming of the module. For example, FIG. 1 illustrates the modules 162 in the storage device 160 configured to control the processor 120. These modules may be stored on the storage device 160 and loaded into RAM 150 or memory 130 at runtime or may be stored as would be known in the art in other computer-readable memory locations.

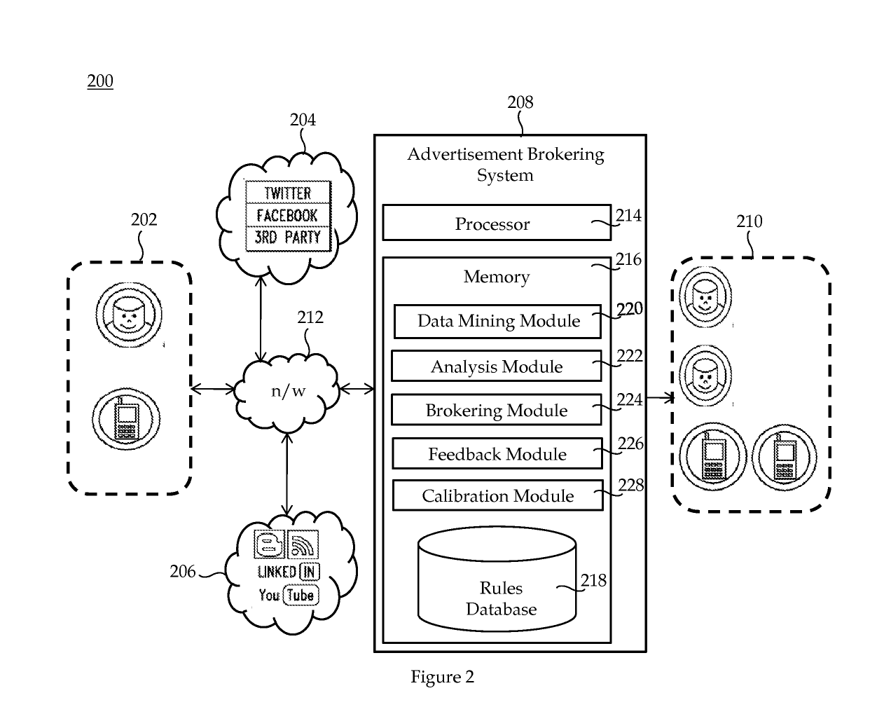

FIG. 2 illustrates a network environment 200 in which the various embodiments of the present invention may be implemented. As shown in FIG. 2, the network environment 200 includes social media user terminal 202 associated with a social media user, direct social media channel 204, indirect social media channels 206, an advertisement brokering system 208, and a system user terminal 210. The elements 202-208 may be connected via at least one network 212. The network 212 may include, but is not restricted to, a communication network such as PSTN, Local Area Network (LAN), Wide Area Network (WAN), Metropolitan Area Network (MAN), and so forth. In an embodiment of the present invention, the network 212 may be a data network such as the Internet.

In an embodiment of the present invention, social media user terminal 202 represents a social media user whose activities using social media channels 204 and 206 are being monitored by the advertisement brokering system 208. The social media user terminal 202 may include a computing device of a user, for example, a smart phone, a laptop, a desktop, a tablet etc. Further, the system user terminal 210 may represent an advertiser wishing to present targeted advertisements. The terms “social media user” and “user” may be used intermittently throughout the specification. In addition, the terms “system user” and “advertiser” may be used intermittently throughout the specification.

Further, as shown, the network environment 200 includes the social media channels 204 and 206 connected to the advertisement brokering system 208 via the network 212. In an embodiment, the direct social media channel 204 refers to a social media channel that provides an application programming interface (API) middleware interface that is accessible by advertisement brokering system 208. The direct social media channel 204 may include social networks, such as, but are not limited to, “Twitter”, “Facebook”, and other third party databases. Furthermore, the indirect social media channels 206 refers to media channels that do not provide an API middleware interface that is accessible by advertisement brokering system 208. The indirect social media channel 206 may include online databases such as, but are not limited to, video service providers, podcasts, blogging websites, or other third party databases.

Further, in the various embodiments of the present invention, the advertisement brokering system 208 may be configured to support a variety of communication modes. For example, the advertisement brokering system 208 may be configured to support a client-server communication mode with one or more of direct social media channels 204. That is, advertisement brokering system 208 may initiate a request for information by way of a standardized message such as a message in accordance with an API interface understood by direct social media channel 204. Further, the direct social media channel/client 204 may act as a server and deliver the requested information to advertisement brokering system 208. However, the various embodiments are not limited in this regard and any other type of communication mode may also be used.

The social media user terminal 202 may be configured to support the communication modes described above using a wide variety of devices, including devices operating over analog or digital communication channels designed for the delivery of information to users in an audio form, a visual form (including static and dynamic visual elements), or any combination thereof. For example, in some embodiments of the present invention, social media user terminal 202 may include a general purpose computer device connected to the data network 212, as described above with respect to FIG. 1. Such devices may include a desktop computer, portable computer, personal digital assistant, smart phone, or any other type of appliance or device having access to one or more data networks supporting real-time and/or time-shifted communication modes over such networks. However, the various embodiments are not limited in this regard. For example the social media user terminal 202 may be devices supporting communications over telephony networks or any other type of communication networks. Such devices may include land-line telephone devices, mobile or cellular telephone devices, videophone devices, and the like. However, the various embodiments are not limited in this regard and any other types of devices may be used for social media user terminal 202.

Further, in another embodiment of the present invention, the social media user terminal 202 may communicate in various ways. In one embodiment of the present invention, a web surfer user makes use of the social media user terminal 202 to establish a communication session with one of the social media channel 204 and/or 206. For example, the customer may establish a telephony communication link with a web site hosting a social media channel 204. In another embodiment of the present invention, the customer may establish a communication session over a videophone, instant messaging, or other real-time communications means.

As shown in FIG. 2, social media channel 204 and 206 are accessible through the network 212 and may include direct and indirect social media channels, respectively, with respect to the advertisement brokering system 208. Enterprises and the advertising/marketing agencies that represent them bid for advertising space on various host communication channels, e.g., web sites, on cable and network TV, on social networks, in magazines, on the radio, and so forth, in order to communicate with predetermined targeted audiences. These advertisements may be brokered by third parties, or may be a result of a transaction directly between the advertisers and the hosts. Advertisers select a host based on factors such as desired demographics of users of various host channels and customer characteristics, but have limited insight into customer behavior, in particular when it comes to a before/after comparison in order to gauge or analyze the effectiveness of advertising and a marketing campaign.

Embodiments in accordance with the present invention provide an ability to broker, in real time, access to specific individuals on social networks, based on monitored social network activity. Embodiments may analyze potential customers' social network activity—postings, likes, and observable migration across the online presence of a company of interest (e.g., web pages, social media channels, business blogs, etc.), along with available social data about specific users. Embodiments may then classify social media users in real time based on observed characteristics and demographics, and match the observed characteristics and demographics against desired characteristics and demographics.

A system and/or method in accordance with an embodiment of the present invention may start with lists or definitions of desired customer characteristics and/or behavioral traits that an interested party (i.e., a user of embodiments in accordance with the present invention) has determined in advance would characterize a social media user whom the interested party would prefer to target for advertisements. Information whether a social media user meets the desired customer characteristics may be gathered at least in part by accessing API interfaces provided by some social media networks, tracking cookies, observed social media user migrations from one company to another, and so forth, either individually or in combination. For example, a user of embodiments may specify that he/she is interested in individuals who are highly active on a social network, have a predetermined demographic characteristic, and have recently been a “liker” of a company in a predetermined industry sector and have just recently “liked” another company in the same sector. Embodiments may monitor social media users' social network activities and profiles in order to detect a match. If a match has been detected, embodiments notify users of embodiments who are seeking such social media users, and a bidding process may be opened in order to broker an ability to target a posting, advertising, a customized widget set, or some personalized communications to the detected social media user.

Embodiments in accordance with the present invention may further include a brokerage service that provides brokering services for the rights to advertise to the detected social media user, in real-time. Embodiments in accordance with the present invention may also include a system to automatically generate personalized advertisement and communication channels. System embodiments may further include a user interface such that a user of an embodiment may configure the characteristics of a desirable social media user. The system may further include communication interfaces to/from external sources of user activity.

In an embodiment of the present invention, the advertisement brokering system 208 may be configured to analyze effectiveness of an advertising campaign. For example, effectiveness may be inferred from changes in social media usage, and more specifically to changes in social media usage, patterns of behavior, etc., from a point in time before the start of an advertisement campaign to a point after the campaign has begun (e.g., during or after the campaign).

For example, embodiments may record observable customer's behavioral activities from configured data sources (e.g., social media, Web, blogs, etc.) for the targeted social media user demographics. After the bidding process has concluded and/or at the beginning of the marketing or advertising campaign, embodiments may keep monitoring the observable behavioral activities of the targeted social media user demographics. At predetermined time intervals, embodiments may compare the observed customer behavior with the previously recorded social media activities by the targeted users. If the analyzed difference exceeds predetermined and configurable thresholds of metrics, embodiments may notify the successful bidder(s) who can then take reinforcing or corrective action as needed. For example, a company “C” may have successfully bid on targeting a set of users “U” with a new promotion. “U” contains users who were once highly active on C's social media page but then migrated to the social media pages of competing companies “D” and “E” where they show strong page engagement (i.e., usage) through their activities. In particular, these activities may include postings about purchases from “D” and “E” that users want to share. The before and after analysis might reveal that of these users, only those who had migrated to “D” are returning to C's social media page in significant numbers. By notifying “C” of this fact, the system allows “C” to fine-tune its promotion to also recapture the users who had migrated to company E's social media page.

Thereby, embodiments not only allow more refined targeting of desirable customers but also to better measure the impact of marketing and advertising campaigns in a novel and direct way and in near real-time.

In some embodiments in accordance with the present invention, a final user may be defined and/or created dynamically in real-time, based on what is detected by the monitors of social networks. For example, if an event happens or a great amount of new social media activity is detected, then the subject matter of that social media chatter becomes a new segment, or a new type of category, such that advertisers can bid on serving those people.

In an example, embodiments in accordance with the present invention may monitor substantially continuously for predetermined activities that a web surfer conducts while visiting a social networking site, in particular one or more predetermined business or personal Facebook pages, which may be grouped into in a configurable set of Facebook pages known as a “Page mix”. Predetermined activities may include posting of messages (i.e., “posts”), comments (e.g., responses to other posts), likes or dislikes, posting or viewing of photos, tags (i.e., identification of a person in a photo), and substantially any other publicly visible user and/or page-owner expressions.

The Page mix may contain a link not just to the social media or web pages of a business's known competitors' Pages, but also a link to Facebook Pages of other businesses (e.g., competitors, suppliers, customers, peers, etc.). An activity recorder records new activities and adds the new activities to a repository of activities that can be searched by either Page ID or activity owner ID.

At certain time intervals before, during and/or after an advertising campaign, a system in accordance with an embodiment of the present invention analyzes the activity repository. To illustrate the type of analysis that embodiments perform, consider a company “A” that has competitors in the same or similar industry, market, region, etc. A system user may want to discover a migration pattern of an overall population of the companies. In particular, the system user may want to know who and how many people migrate away from the company “A”, how often, for how long, which directly competing companies and/or less directly competing companies they preferably migrate to, what online activities they undertake related to these companies and for how long, who returns to the company “A” and when, which competing companies have strong “affinities”, e.g., reciprocal migration streams of roughly equally strong in both directions, which pairs of companies have very lopsided migration streams (i.e., strong migration in one direction but weak migration in the other), etc.

Embodiments in accordance with the present invention may also compute temporal migration metrics that indicate, for example, how “bursty” or how continuous that the migration patterns are. Bursty migration patterns may be correlated with events, such as start/stop/step-up/step-down of an advertising campaign or other significant events related to the advertising campaign or inside a company, in the business sector, or the wider world, in order to explain sudden changes in migration patterns. Ultimately, a business conducting this type of analysis may gain valuable insights into the behavior of Web surfers with respect to its own online advertising and the advertising and/or social media presence of its competition. Such insights may prompt the business to change its marketing practices.

In some embodiments in accordance with the present invention, temporal proximity between events may indicate greater or lesser perceived importance, relevance, relatedness, correlation, or the like, to a social media user. In some embodiments, both temporal closeness as well as distance may be important.

A system embodying the present invention may be hosted on substantially any sufficiently robust computing platform (i.e., a system server) having Internet access. In particular, the system server does not need to be a web server hosting any of the monitored pages. However, the system server should have access to, and be able to invoke and/or interpret, application programming interface (“API”) middleware that may be made available to external developers by social networking sites such as Facebook. The system server of embodiments in accordance with the present invention performs an ongoing data mining functions using the API middleware. The API middleware offers an interface by which a system user can track activities of web surfers on each monitored page. For example, a Facebook API may provide information on real-time observable behavioral activities such as who posts what on a vendor's Facebook page, who comments on the vendor's Facebook page, who tagged it, who likes (or dislikes) that page, and so on. Certain simple activities by a web surfer, such as simply viewing a web page, do not currently provide an observable event that is reported by the API middleware.

Embodiments in accordance with the present invention may provide an ability to track a web surfer who jumps back and forth between different social networking platforms, each of which may have their own customized API middleware interface. The tracking may be accomplished by way of an ID, which may be system assigned or derived from a characteristic such as an IP address. The set of observable activities would vary from one social networking platform to another and may include activities like following, becoming a fan, posting a tweet, interacting on a business web page, and so forth.

In some embodiments in accordance with the present invention, a system may be incorporated with and/or tied to a web server of an organization deploying the embodiment. For example, suppose a company “A” desires to monitor the behavior of web surfers to their Facebook page as well as to the Facebook pages of their competitors “B” and “C”, as described above. Embodiments may be co-located or co-hosted on the web server of company A. Observation of track-able activity related to competitors “B” and “C” would still occur by use of the API middleware. However, co-location in this way allows for tighter integration with the company “A”, and possibly being able to analytically data mine additional information related to the company “A” that is not available through API middleware, such as the web surfer's interaction with a public web site of the company “A” (not limited to a Facebook page).

Referring again to FIG. 2, as shown, the advertisement brokering system 208 includes a processor 214, and a memory 216. The memory 216 further includes a rules database 218 and a plurality of modules, such as, but are not limited to, data mining module 220, analysis module 222, brokering module 224, feedback module 226, and calibration module 228. Further, the rules database 218 may store rules for selecting and analyzing social media events.

The data mining module 220 is configured for mining data from predetermined resources (such as, but not limited to, Internet, social media channels 204, social media channels 206, or other social media websites) corresponding to certain users who possess certain predefined characteristics. The predefined characteristics may include, but not limited to, specific demographics, categories, profiles, or attribute sets. In an exemplary embodiment of the present invention, the data mining module 220 is configured for analyzing/mining data from the Internet related to, but not limited to, social network posting history of at least one user, content of the postings made by the user, data present in the social network profiles of the user, social networking profiles of the user's friends/acquaintances, cross page metrics (jumping pattern of the user from one web-page to another) of the user, and data present about the user in blogs, news, or other online databases that are connected with the Internet. Further, in an embodiment, the data mining module 220 is configured to monitor behavior of the user on the social media channel 204, or the social media channel 206. In an embodiment, data mining module 220 may use software robots for mining data from the Internet. Such data mined by the data mining module 220 may enable the advertising brokering system 208 to determine advertisers for which the mined information may be useful.

In an embodiment, the data mining module 220 enables one or more pre-registered advertisers to provide desired characteristics of the users. In another embodiment, the data mining module 220 may receive a list of the predefined characteristics of users from one or more advertisers or advertising agencies (such as the users of the system user terminal 210). Further, the data mining module 220 may mine/monitor social media related data from social media channel 204. A primary source for collecting the social media data may be via API functions available from social media channel 204. However, information included in the social media related data may provide a limited view of the overall characteristics of the social media user, specifically the characteristics of the social media user with respect to the indirect social media channel 206.

Accordingly, in another embodiments of the present invention, a secondary source of social media related data is utilized, i.e., indirect social media channels 206. In particular, the advertisement brokering system 208 is configured to access and monitor indirect social media channels 206 for social media related data. As a result, the social media related data so collected may add additional aspects of the social media user's interest. Thus, the composite social media related data may more accurately reflect the overall characteristics of the social media user and allows the advertisement brokering system 208 to provide a more customized view of the social media user's interaction with social media.

In an embodiment of the present invention, the data mining module 220 is configured to retrieve social media users' observable events. According to an embodiment of the present invention, the data mining module 220 relies on API functions publicly available from the direct social media channels 204. The data mining module 220 is also configured to retrieve information from indirect social media channels 206. According to yet another embodiment of the present invention, the data mining module 220 is further configured to retrieve information from social media presence of competing, complementary, and partner businesses.

Further, the data mining module 220 may operate as a data aggregator collecting information regarding the social media users' interactions from social media channel 204 and 206. Alternatively, data mining module 220 may be configured to operate with other modules, internal or external to the advertisement brokering system 208, for collecting data regarding the social media users. For example, the data mining module 220 may be configured to operate with a third party aggregator system (not shown) connected to the network 212.

The analysis module 222 may be configured for identifying users based on match of the mined data (by the data mining module 220) with the predefined characteristics. In an embodiment, the analysis module 222 may also be configured to match the mined data (having information corresponding to user's monitored online behavior and activities such as, posting history and content, user profile data and friends network, and cross page matrices) with a set of rules stored in the rules database 218. Such set of rules may further be determined based on the mined data.

For example, data mining module 220 might detect a situation where a “loyal user” who has a history of posting at social networking page of organization “A”, suddenly starts posting on biggest competitor (say organization “B”) of the organization “A”. In an embodiment, the analysis module 222 may refer to the rules stored in the rules database 218 to determine whether a user is loyal or not. Further, the analysis module 222 may also be configured to identify a situation where a loyal user suddenly turns disloyal. Such analysis may be forwarded to relevant advertisers (such as the organization A and organization B) to bid for providing promotional offers to target the user.

In an embodiment, the analysis module 222 may receive data mined by the data mining module 220 corresponding to specific users performing desired behavioral activities and/or possessing the predefined characteristics as required by the advertisers. The analysis module may then use the received data corresponding to the specific users to generate at least one profile for each of the specific users. The profile may include all the data that is mined by the data mining module 220 and is relevant for the advertisers (based on the predefined characteristics list received from the advertisers). Thereafter, the analysis module 222 may share the generated profiles of the specific users with the pre-registered advertisers for bidding. The advertisers may then analyze the profiles to determine profiles those are more relevant for their business.

In an embodiment of the present invention, the analysis module 222 may be set to uniquely identify social media users having characteristics as defined by the advertisers. Furthermore, the analysis module 222 of the advertisement brokering system 208 may be used to at least partially analyze the collected social media user's data. For example, the analysis module 222 may be configured to identify/filter irrelevant social media user data, to rank the information according to a relevance to a particular criterion, or to classify information according to subject, topic, product, and/or any other classification scheme. The analysis module 222 may also be configured to store criteria/rules for selecting and analyzing social media events in rules database 218.

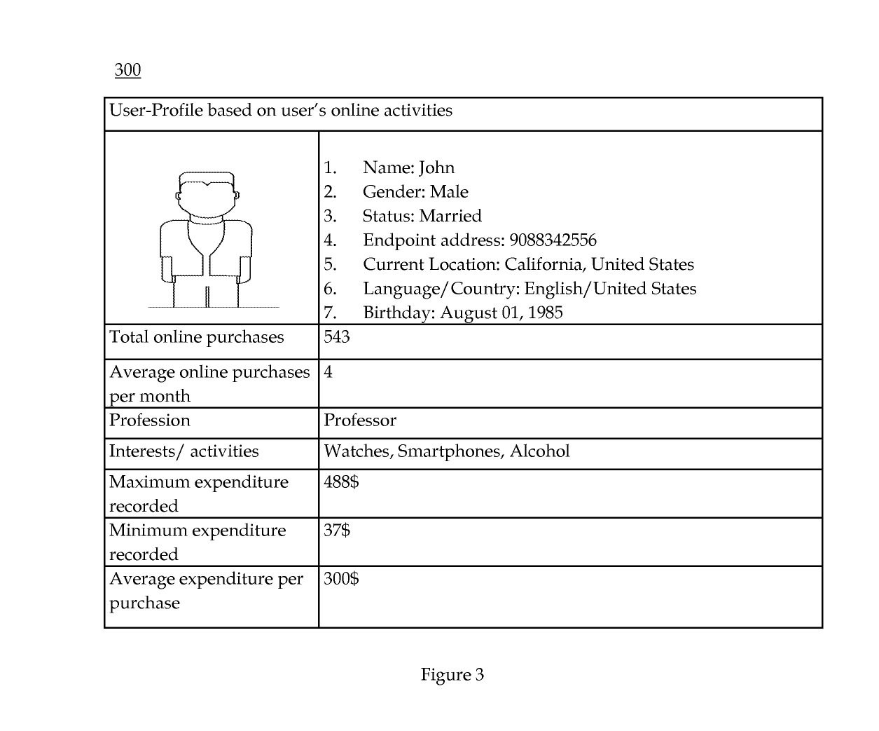

Further, the profiles generated by the analysis module 222 of the social media user can be temporarily/permanently stored in the memory 216 and can be used for future reference and usage. The profiles may be based upon social media usage by the web surfers/social media users. An exemplary profile created by the analysis module 222 is illustrated in FIG. 3 of the present invention. Further, the analysis module 222 may be configured to build social media user profiles that may include self-description, social circles, posts, likings, locations etc. According to an embodiment of the present invention, the social media data may be retrieved by the data mining module 220 periodically/continuously at configurable intervals.

In yet another embodiment of the present invention, the analysis module 222 may be configured to incorporate the retrieved social media content into extended attribute sets of the profile. The attribute sets of the social media user may include social interests, education and work histories, hobbies, hometowns, favorite sport teams and TV shows, cultural background, and so on. The social media user's posting history may reveal a lot about the social media user's interests related to the business. The social media user interest set is updated that may include the results obtained by the data mining module 220.

Further, the profile of the social media user maintained by advertisement brokering system 208 may be updated automatically at configurable intervals after social media user data from the mining process is available. The public visibility of user and business activities and interactions on public social networks provides us with a unique opportunity to compute user migration patterns across social network pages that are of concern to the new, social contact center (contact center+Marketing+Sales+Public relations, representing a business on the social network).

The brokering module 224 may be configured for offering advertising services (such as personalized advertisements) to the identified users (identified by the analysis module 222). The brokering module 224 may generate personalized advertisements for each identified user based on the identified user's data mined by the data mining module 220 and based on requirements of advertisers. In an embodiment, the brokering module 224 may allow only one advertiser to directly target a specific user for advertisements. The brokering module 224 may then request the advertisers to bid for the profiles shared by the analysis module 222.

The advertisers may then analyze the profiles to select at least one profile that is relevant to their point of interest (based on user's profile data). Based on profile selections, the advertisers may communicate their bidding amounts for one or more user profiles to the advertisement brokering system 208. The brokering module 224 of the advertisement brokering system 208 may receive the bidding amounts for one or more users. The brokering module 224 may then determine a highest bidding amount and may select corresponding highest bidding advertiser for each user (for whom a bid is received).

Thereafter, the brokering module 224 may query the highest bidding advertiser corresponding to details of the advertisement(s) that is required to be sent to targeted user (for whom the advertiser placed highest bid). In an embodiment, the brokering module 224 may enable the highest bidding advertiser to establish a direct communication session/channel (Internet chat, voice call, SMS, video call etc) with the user targeted by the advertiser. In another embodiment, the brokering module 224 may automatically create an advertisement (that is personalized for the targeted user based on services offered by the advertiser) based on the data mined by the data mining module 220 and based on predefined characteristics list initially received by the data mining module 220 (from the advertiser). Thereby, the brokering module may generate an advertisement for selected advertiser.

In an embodiment, the brokering module 224 may provide the personalized advertisement to the targeted/identified user by posting the personalized advertisement on social network wall/profile of the user. In another embodiment, the brokering module 224 may advertise the targeted user via Internet chatting means. In still another embodiment, the brokering module 224 may advertise the targeted user over a voice/video call. In yet another embodiment of the present invention, the brokering module 224 may advertise the targeted user via graphical or text advertisements.

Further, after advertising the targeted user, the brokering module 224 may instruct/request the data mining module 220 to monitor activities of the targeted user to determine reactions/response of the targeted user after encountering with the personalized advertisement. In an embodiment, the data mining module 220 may not need to receive request from the brokering module 224 to monitor activities of the targeted user, as the data mining module 220 may be continuously monitoring online activities of the targeted user. Furthermore, the data mining module 220 may be configured to provide the monitored data to the feedback module 226 for further analysis.

The feedback module 226 may be configured to receive monitored data from the data mining module 220. In an embodiment, the monitored data may include data monitored before and after advertising the targeted user. Based on the received monitored data, the feedback module 226 may analyze difference in the activities of the targeted user before and after encountering with the personalized advertisement. In an embodiment, the targeted user may get lured by the personalized advertisement and may indulge in business activity with the highest bidding advertiser. In another embodiment, the targeted user may not be impressed with the personalized advertisement and may either ignore the personalized advertisement or may either move on to other stuff that may be more relevant or interesting for the targeted user.

The feedback module 226 may analyze such behavior change in the targeted user and may report the same to the highest bidding advertiser. The feedback module 226 may therefore notify the highest bidding advertiser corresponding to the changed online activities of the user after posting of the personalized advertisement compared with previous activities of the user before posting of the advertisement. In an embodiment, the feedback module 226 may generate a feedback report for the highest bidding advertiser. The feedback report may include detailed data corresponding to online activities of the targeted user before, during, and after providing the personalized advertisement.

The highest bidding advertiser then analyzes the change in the activity of the user and may instruct the advertisement brokering system 208 to fine-tune the advertisement for making the advertisement more relevant and alluring to the user. In an embodiment, the highest bidding advertiser may provide data related to the new advertisement to the advertisement brokering system 208. In another embodiment, the highest bidding advertiser may ask the advertisement brokering system 208 to build the new advertisement based on the change monitored in the activities of the user.

The calibration module 228 may be configured for receiving instructions from the highest bidding advertiser for corrective actions to calibrate or fine-tune advertisements as per the newly monitored activities of the targeted/identified user. The calibration module 228 may be further configured to fine-tune/generate a revised advertisement based on the instructions received from the highest bidding advertiser. In an embodiment, the calibration module 228 may use previously generated advertisement and may fine-tune the advertisements based on the monitored user activity for making the advertisement more appealing and relevant. In another embodiment, the calibration module 228 may generate a completely new advertisement based on the monitored activity of the user. In yet another embodiment, the calibration module may provide revised advertisement to the identified users based on corrective actions received from the highest bidding advertiser.

For example, a user started following a social networking webpage of a cell phone selling company. The advertisement brokering system 208 informs the cell phone selling company about the user being interested in their products. The cell phone selling company instructs the advertisement brokering system 208 to send advertisement to the user. The advertisement brokering system 208 provides a promotional offer to the user related to a cell phone “X” in 400$ (based on user's web surfing history). The user ignores the promotional offer and visits a webpage of cell phone “Y” of the same company. The advertisement brokering system 208 monitors this activity and informs the cell phone selling company about the same. The cell phone selling company instructs the advertisement brokering system 208 to provide another advertisement related to the cell phone “Y”. The advertisement brokering system 208 then generates and displays new advertisement related to the cell phone “Y” and again starts monitoring activity of the user.

Further, in an exemplary embodiment of the present invention, after providing the calibrated advertisement, the data mining module 220 may again monitor the activities of the targeted user to determine change in activities after noticing the calibrated advertisement. The feedback module 226 may again generate and send second feedback report to the highest bidding advertiser and based on the instructions of the highest bidding advertiser, the calibration module may again generate a third advertisement and the process may continue until the highest bidding advertiser gets satisfied with the activities of the targeted customer.

Further, in an exemplary embodiment of the present invention, the data mining module 220 may detect a new event or detect a major amount of new social media activities. The data mining module 220 may be configured to notify plurality of advertisers corresponding to the newly detected activity. The advertisers may then start selecting new target users from the newly activated social media activity.

In an embodiment, the data mining module 220 may be configured to detect new activities on social networks. In another embodiment, the data mining module may be configured to detect major social media activities on social networks. Further, based on the newly detected social media activities, the data mining module 220 may detect new characteristics of users who are involved in the newly detected social media activity. Furthermore, the brokering module 224 may be configured for providing advertising services for the new characteristics of the users.

For example, on a chocolate day, the advertisement brokering system 208 may detect that a lot of people are buying chocolates. The advertisement brokering system 208 may then notify all chocolate sellers for the same. The chocolate sellers may then start bidding for customers identified by the advertisement brokering system 208. Thereafter, on rose day, the advertisement brokering system 208 may detect that a lot of people are buying roses. The advertisement brokering system 208 may then again notify all floweriest and the advertisement brokering system 208 may then start serving for the people who are interested in buying roses.

FIG. 3 illustrates an exemplary view of a user-profile 300 created by the advertisement brokering system 208 for the advertisers, in accordance with an embodiment of the present invention. In an embodiment of the present invention, the advertisement brokering system 208 may monitor activities of a user over a network. The advertisement brokering system 208 may further use monitored data to generate a profile of the user, such as user-profile 300. The user-profile may include data corresponding to the user. The data may include, but is not limited to, personal data, professional data, web-surfing history, social network usage-specific data, demographic data, and like.

Further, the user-profile 300 of the user may be used by the advertisers to determine business potential in the user. Details provided in the user-profile 300 may facilitate the advertiser to determine probability of luring the user to either make a purchase or to perform an activity. The activity may include, but is not limited to, reading an article, watching a video, filling a survey, supporting a cause, donation etc. According to an embodiment of the present invention, the user-profile 300 of the user may include information such as, but not limited to, users' name, status, work and home location, language, education level, work history, favorite TV shows, books, or music etc. However, the various embodiments are not limited in this regard and other types of user data may also be provided without limitation.

The user-profile 300 of the user may also include additional information including online purchasing history. Further, as shown in the user-profile 300, the additional information elements may include e-commerce characteristics of the user, such as total purchases, average purchases made every month, profession of the user, interests of the user in online shopping, maximum expenditure recorded from the user, minimum expenditure recorded from the user, average expenditure per purchase etc. As a result, this information may help the advertisers to build activity set for facilitating social media-aware advertisement brokering.

For example, as shown in FIG. 3 of the present invention, advertisers can determine that the user-profile 300 is relevant only for those companies who deal either in watches, smart phones, or liquor. Therefore, only companies who manufacture, promote, or sell watches, smart phones, or liquor may be interested in bidding for the user-profile 300. Further, to determine bidding amount, the companies may refer to information such as “Maximum expenditure recorded” or “Minimum expenditure recorded” to determine profitable margin expected from the user. Based on the expected profitable margin, the companies may determine suitable bidding amounts.

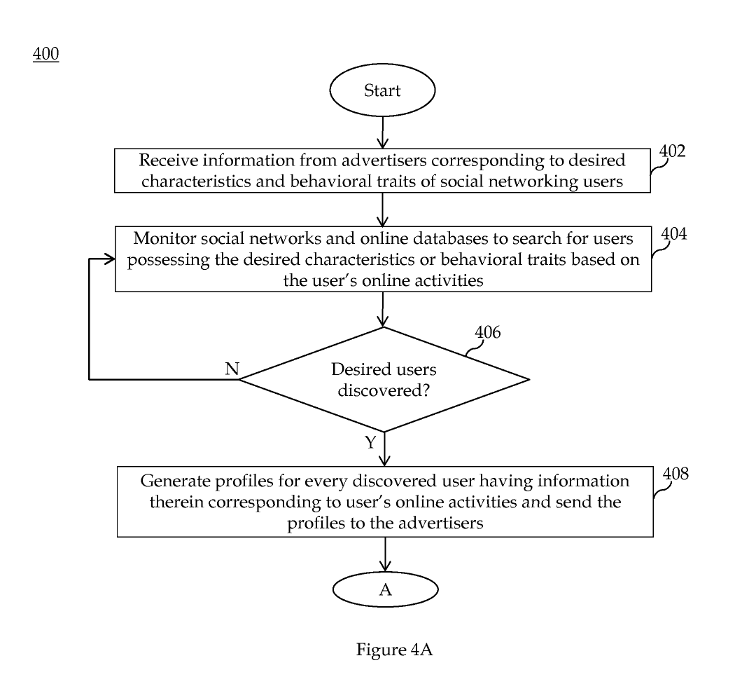

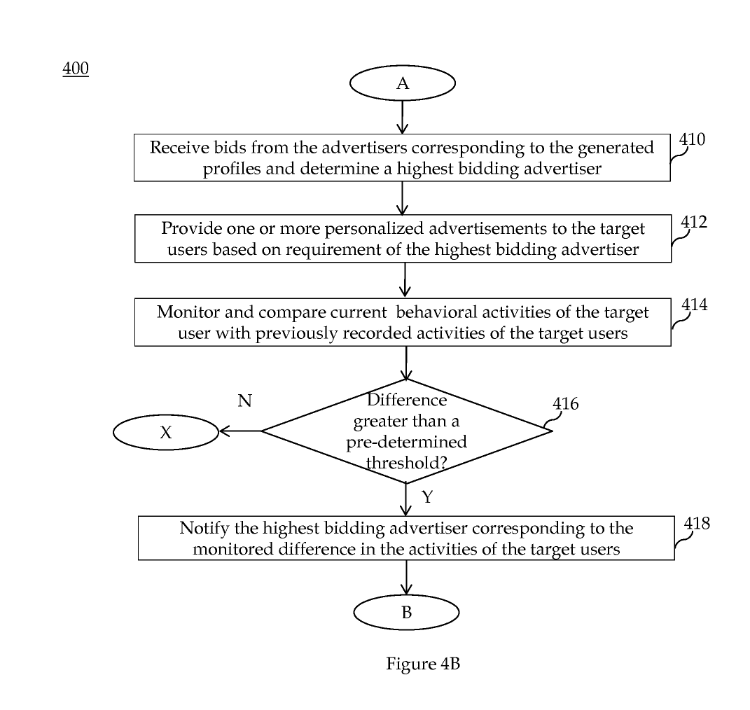

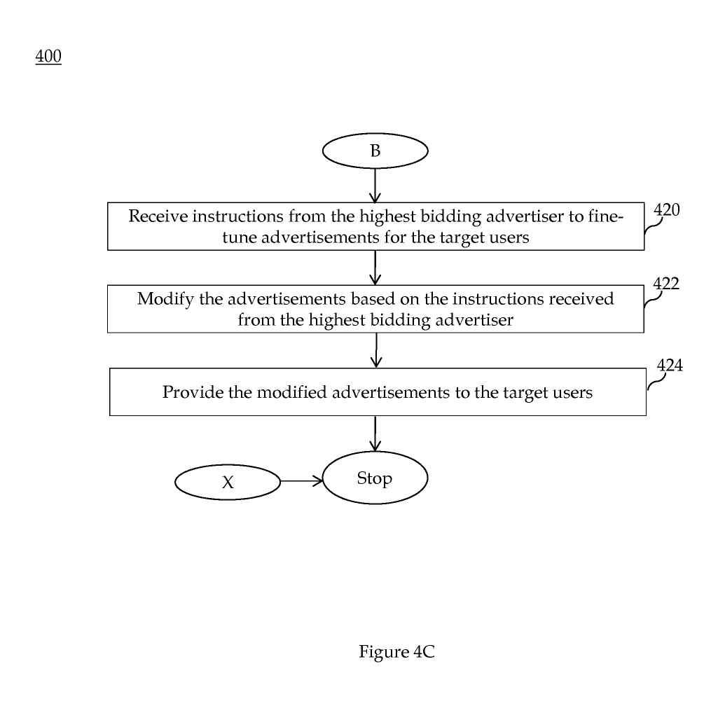

FIGS. 4A, 4B, and 4C illustrate a method 400 for brokering advertisement services, in accordance with an embodiment of the present invention. The method enables a plurality of advertisers to target a categorized set of users over a network to develop their business opportunities. At step 402, a list of the desired/predefined characteristics and behavioral traits corresponding to social networking users is received from one or more advertisers or advertising agencies. In an embodiment, every advertiser may have a different requirement, or a group of advertisers may have similar requirements of having a set of users with certain characteristics.

Further, at step 404, based on the requirements of the advertisers, various social networks and other related online databases are searched for users possessing the desired/predefined characteristics and behavioral traits (as desired by the advertisers). In an embodiment, the searching may include monitoring online activities of various social networking users. Further, based on the predefined characteristics and behavioral traits received from the advertisers, data mining from certain predetermined resources (such as social networks) may be initiated. In an embodiment, various social networks and similar online databases may be monitored to search for users possessing required predetermined characteristics.

In another embodiment, behavioral activities and profiles of users from the monitored social networks (such as social media users) may be tracked to search for those users who possess desired predetermined characteristics or behavioral traits (as required by the advertisers). In an embodiment of the present invention, social network activities and profiles of all the users (active on social networks) are continuously monitored. In another embodiment of the present invention, certain predetermined activities such as, but not limited to, message posting, commenting, liking, disliking, information viewing, and observable migration over web pages, social media channels, business blogs, and like may also be searched. In an embodiment, the step 402 and the step 404 may be performed by the data mining module 220.

At step 406, identification of users with desired predetermined characteristics and behavioral traits may be started based on match of the mined data with the predefined characteristics (received from advertisers). The searching and identification may continue until at least one user with desired predetermined characteristics or behavioral traits is found. In case, if no user with the desired characteristics is found then the method steps back to step 404 for continuing monitoring of more social networking users to search at least one user with desired characteristics or behavioral traits. Otherwise, if at least one user is found (hereinafter, may be referred to as “targeted user”) having the desired predetermined characteristics then the method may proceed to step 408.

At step 408, based on the data monitored corresponding to the one or more targeted users, respective profiles (such as user-profile 300) of the targeted users may be generated. Thereafter, it is notified to the advertisers that one or more users are identified having the desired predetermined characteristics and/or desired behavioral traits. In an additional step, the generated profiles are sent to relevant advertisers i.e., only to those advertisers who requested similar characteristics as found in identified user profiles. In an embodiment, the step 406 and the step 408 may be performed by the analysis module 222.

Further, as shown in FIG. 3B and at step 410, preregistered advertisers (who provided list of desired predetermined user characteristics) are requested for sending bids based on the generated profiles. Thereafter, the bids from the advertisers corresponding to the generated profiles are received. The bids received for every generated profile to determine a highest bid for every profile is compared. Thereafter, the highest bidding advertiser is notified suitably.

Furthermore, the highest bidding advertiser may either prepare a suitable advertisement or may send a request to generate a suitable advertisement based on the data monitored for the targeted user. In an embodiment of the present invention, the highest bidding advertiser is enabled to target a posting, advertising, a customized widget set, or some personalized communication to the identified user. In another embodiment of the present invention, the highest bidding advertiser is enabled to advertise to the identified users, in real-time.

At step 412, the targeted users are offered advertising services. In case, if the highest bidding advertiser provides any advertising material then the material may be further provided to the identified user through suitable means. However, if the highest bidding advertiser requests to generate an advertisement then one or more personalized advertisements or advertising communication channels for the identified user may be generated. These communication channels allow the advertisers to connect with the identified users over the network. In an embodiment, the step 410 and the step 412 may be performed by the brokering module 224.

At step 414, monitoring of behavioral activities of the targeted user over the network is continued even after providing one or more personalized advertisements to the targeted user. Further, based on the behavioral activities that were monitored prior to providing advertisement to the targeted user and based on the behavioral activities monitored after providing advertisement to the targeted user, a difference or variation in the activities is compared and determined.

At step 416, the difference determined in the user behavioral activities is compared with a predetermined threshold amount. In case, if the determined difference is greater than a predetermined threshold then the method may proceed to step 418. In another case, if the difference is not exceeding the predetermined threshold limits, then the method may end. Further, at step 418, the highest bidding advertiser is notified corresponding to the high difference in the activities of the target user. The advertiser may then determine strategies to re-gain interest of the targeted customer for its social web-pages. In an embodiment, higher difference in the activities signifies that the targeted customer is not lured by the advertisement. In another embodiment, higher difference may signify that the targeted customer has moved away from the social webpage of the advertiser. In an embodiment, the step 414, step 416, and step 418 may be performed by the feedback module 226.

At step 420, as shown in FIG. 4C, instructions from the highest bidding advertiser are received to fine-tune/calibrate advertisements for the target user. In an embodiment, the advertiser may provide suggestions to calibrate the advertisement. In another embodiment, the advertiser may send a request to calibrate the advertisement based on the monitored activities of the targeted customer.

At step 422, based on the instructions received from the highest bidding advertiser, the advertisements may be fine-tuned or calibrated. In an embodiment, based on requirement, a new advertisement may also be generated. In another embodiment, type/style/or essence of the advertisements may also be changed. For example, if a graphic advertisement was previously provided, then this time a video or audio advertisement may be provided. Thereafter, at step 424, the calibrated/generated advertisement may be provided to the targeted user(s). In an embodiment, the step 420, step 422, and step 424 may be performed by the calibration module 228.

Embodiments of the present invention include a system having one or more processing units coupled to one or more memories. The one or more memories may be configured to store software that, when executed by the one or more processing unit, allows practicing of embodiments, at least by use of processes described herein.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations are possible in light of the above teachings or may be acquired from practice of the present invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the present invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

What is claimed is:

1. An advertisement brokering system, comprising:
a data mining module for mining data from predetermined resources based upon predefined characteristics of users;
an analysis module for identifying users based on match of the mined data with the predefined characteristics; and
a brokering module for offering advertising services to the identified users.

2. The advertising brokering system of claim 1, wherein the data mining module further enables one or more advertisers to provide desired characteristics of the users.

3. The advertisement brokering system of claim 1, wherein the predetermined resources comprising social media websites.

4. The advertisement brokering system of claim 1, wherein the brokering module further notifying a plurality of pre-registered advertisers for sending bids.

5. The advertisement brokering system of claim 4, wherein the brokering module further selecting an advertiser based on highest bid.

6. The advertisement brokering system of claim 5, wherein the brokering module further generating an advertisement for the selected advertiser.

7. The advertisement brokering system of claim 6, wherein the brokering module further providing the advertisement to the identified user.

8. The advertisement brokering system of claim 1, wherein the data mining module further monitoring the identified user's behavioral activities.

9. The advertisement brokering system of claim 6, further comprising a feedback module for notifying the highest bidding advertiser about changed activities of the user after posting of the advertisement compared with previous activities of the user before posting of the advertisement.

10. The advertisement brokering system of claim 9, further comprising calibration module configured to receive instructions from the highest bidding advertiser for corrective actions.

11. The advertisement brokering system of claim 10, wherein the calibration module is further configured to generate revised advertisement based on the instructions.

12. The advertisement brokering system of claim 11, wherein the calibration module further providing the revised advertisement to the identified user.

13. The advertisement brokering system of claim 1, wherein the data mining module further detecting new characteristics of users based on newly detected social media activity.

14. The advertisement brokering system of claim 13, wherein the brokering module further providing advertising services for the new characteristics of the users.

15. A computer-implemented method for brokering advertisement services, the computer-implemented method comprising:
mining data from predetermined resources based upon predefined characteristics of users;
identifying users based on match of the mined data with the predefined characteristics; and
offering advertising services to the identified users.

16. The computer-implemented method of claim 15, further comprising notifying a plurality of preregistered advertisers for sending bids.

17. The computer-implemented method of claim 16, further comprising generating and posting an advertisement for an advertiser corresponding to highest bid.

18. The computer-implemented method of claim 17, further comprising notifying the advertiser about changed activities of the user compared with previous activities.

19. The computer-implemented method of claim 18, further comprising generating and posting a revised advertisement based on corrective actions received from the advertiser.

20. A computer readable medium storing computer readable instructions when executed by a processor perform a method comprising:
mining data from predetermined resources based upon predefined characteristics of users;
identifying users based on match of the mined data with the predefined characteristics; and
offering advertising services to the identified users.
